(19) United States
(12) Patent Application Publication
(10) Pub. No.: US 2002/0106059 A1
(43) Pub. Date: Aug. 8, 2002

(54) Public service answering point with automatic triage capability

(76) Inventors: Mark W. Kroll, Simi Valley, CA (US); Karl J.F. Kroll, Maple Grove, MN (US)

Correspondence Address: Mark W. Kroll, 493 Sinaloa Road, Simi Valley, CA, 93065, US

(21) Appl. No.: 10/107,834

(22) Filed: Mar. 25, 2002

Related U.S. Application Data
(63) Continuation-in-part of application No. 09/098,315, filed on Jun. 16, 1998, now Pat. No. 6,370,234.

(51) Int. Cl. H04M 11/04

(52) U.S. Cl. 379/45

(57) ABSTRACT

A public service answering point (PSAP) system is taught that will perform a triage on incoming calls both fully automatically and with caller interaction. The system will progressively shave out duplicate and redundant calls and give high priority to calls that may represent a violent crime or life-threatening medical emergency in progress.

This application is a Continuation-in-part of Ser. No. 09/098,315, “Public Service Answering Point With Automatic Triage Capability” filed on 6/16/98.

### BACKGROUND OF THE INVENTION

1. Field of the Invention

This invention pertains to a telephone response system designed primarily for emergency use and teaches a system for a central office responsive to an emergency call or alarm.

2. Description of The Related Art

The emergency phone system in United States is now a very frequently used service. For example, a 911 call is made every 1.5 seconds just from cellular phones. Unfortunately, the system has become bogged down from misuse and also from excessive good citizenry. A typical freeway accident now generates a large number of 911 calls due to the ubiquitous cell phones. In each case a caller is being a good citizen yet is clogging up the system so other new calls cannot get through. It is very common with an overloaded system such as that found in Los Angeles County that calls are placed on hold and many calls are simply not answered.

In one well-publicized case a gang beating took place on a beach in broad daylight and citizens calling in were placed on hold as no 911 operator could take their call.

In Dec. 2000, a 9 year old boy tied up a 911 line in Columbia, Tenn. for 6 hours on a busy Saturday night by making 91 calls and just staying on the line.

Thus, there is a need for an automated system that will sort through emergency calls and eliminate the redundant calls so that the operators will only deal with the true emergencies as well as the minimum number of calls for a given incident needed to dispatch appropriate rescue personnel to that incident.

Brozovich, “Line-Based Public Safety Answering Point,” (U.S. Pat. No. 5,311,569) teaches a basic PSAP with multiple operative stations.

Pirnie, “Emergency Call Answering System,” (U.S. Pat. No. 4,052,569) teaches a PSAP in which the calls are allotted on a sequential basis to the various operators.

There are numerous patents teaching various automated techniques for handling business calls. For example Shaffer, “One Number Intelligent Call Processing System,” (U.S. Pat. No. 6,058,179) teaches the use of “Caller ID” in automatic ordering systems. Shaffer gives an example (35:64-36:18) of someone ordering flowers for their mother. By entering in their mother's phone number the system can do a reverse directory search and log the mother's address. (This is actually not very practical due to the high fraction of Americans that chose to have unlisted home phone numbers.) Importantly, it has no utility for triaging emergency cellular phone calls, as a cell phone number has no relationship to a fixed physical address. Erickson, “Method of Dynamically Assigning Priority to a Call,” (U.S. Pat. No. 6,047,457) teaches the surrender of a “voice” channel to an emergency call. This would not triage the emergency calls but actually increase them by giving them precedence over other radio or phone traffic.

Ironically, the only art found that teaches any sort of automatic allocation of emergency lines teaches completely away from the real present-day need. Nabkel, “Method and System for Regulating Incoming Calls from Multiple Points of Origination,” (U.S. Pat. No. 6,009,153) teaches a phone company switching system (not a PSAP or any kind of call receiving center) that will forward 911 calls to surrounding 911 trunk lines in the event of a local overload. It does not triage the calls but merely distributes the calls. It does not try to shed calls from an incident that is receiving hundreds of calls. Rather, it favors the receipt of this call overload under the theory that bad things can group up around, say, a sports arena after the sporting event (1:62-66) and “downtown nightclubs” on the “weekends” (1:66-2:3). Rather than having an intelligent system detect call duplication the Nabkel idea requires that the calling area and the schedules (for the football game, for example) be programmed into the system (2:23-28 and 8:64-67). Even if there is an unexpected call flood (for say “earthquakes, tornadoes, etc.” the Nabkel system still has no automatic adjustments. Rather, it requires that the preset schedule be “manually overridden” (9:2-5). To fully understand how irrelevant the Nabkel invention is to the cellular phone age one needs to consider an example. Imagine a car fire. Over the course of an hour there can be 10,800 cars going by the car fire. (1 car per second for each of 3 lanes) If only 1% of the drivers are good citizens then the local PSAP will receive 108 calls for the one incident. What would be the impact of the Nabkel invention, if implemented? Absolutely nothing as the car fire was not on a know schedule like a football game. What would happen if hypothetically, an operator did a manual override as taught in Nabkel (9:2-5)? Then the 1080 calls, instead of stacking up locally, would be farmed out to the surrounding cities to clog up their 911 systems. Thus the problem, instead of being controlled is actually exacerbated. Similarly, neither Nabkel nor any of the existing art could have dealt with the young prankster that tied up the Columbia, Tenn. 911 line.

None of these systems teach an automated triage function. None of these systems teaches an interactive approach for dealing with the 911-congestion problem. Thus, there is a need for a public service answering point system that will perform a triage on incoming calls either fully automatically or with caller interaction.

There is a true and unmet need for a 911 PSAP system, which can automatically triage emergency calls—especially cellular phone calls.

### BRIEF SUMMARY OF THE INVENTION

The basic invention is a public service answering point system that will perform a triage on incoming calls either fully automatically or with caller interaction. One object of this invention is to progressively shave out redundant calls. This is necessary, for example, due to the multiplicity of cellular calls that arrive for each highway incident.

A major feature of the invention is the use of an automatic scoring system. A further object is to give high priority to calls that may represent a violent crime in progress.

The invention anticipates a multitude of different triage techniques and scoring systems and a multitude of different voice interactions with the calling party without departing from the spirit of this invention.

### BRIEF DESCRIPTION OF THE DRAWINGS

FIG. 1 shows a 911 PSAP shown in the context of an overall phone and dispatch system. FIG. 1a teaches the PSAP of the instant invention.

FIG. 2 shows one method of the preferred embodiment of the invention.

FIG. 3 shows another method of the instant invention.

FIG. 4 shows an elliptical scoring system for triage based on calling party location with respect to a known incident incident.

FIG. 5 shows another method of the instant invention.

FIG. 6 shows the use of collaborative filtering to find the optimal priority rating for a call.

FIG. 7 shows a method relying on spectral analysis and speech recognition.

FIG. 8 deals with the method of this invention that covers identification procedures.

FIG. 9 shows a method in which the system performs spectral analysis to detect gunshots and screams.

FIG. 10 shows the method using the false-alarm rating for a given address.

### DETAILED DESCRIPTION OF THE INVENTION AND PREFERRED EMBODIMENT

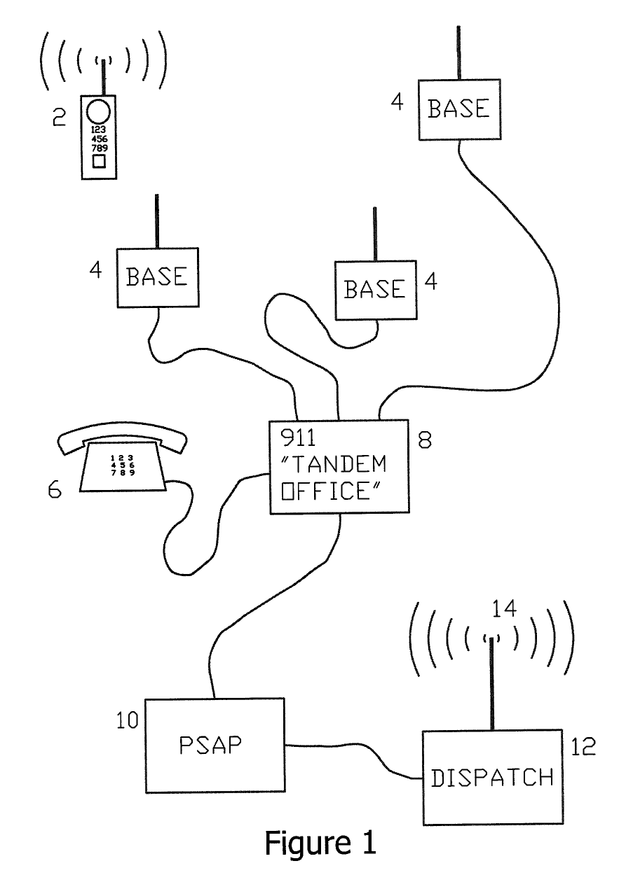

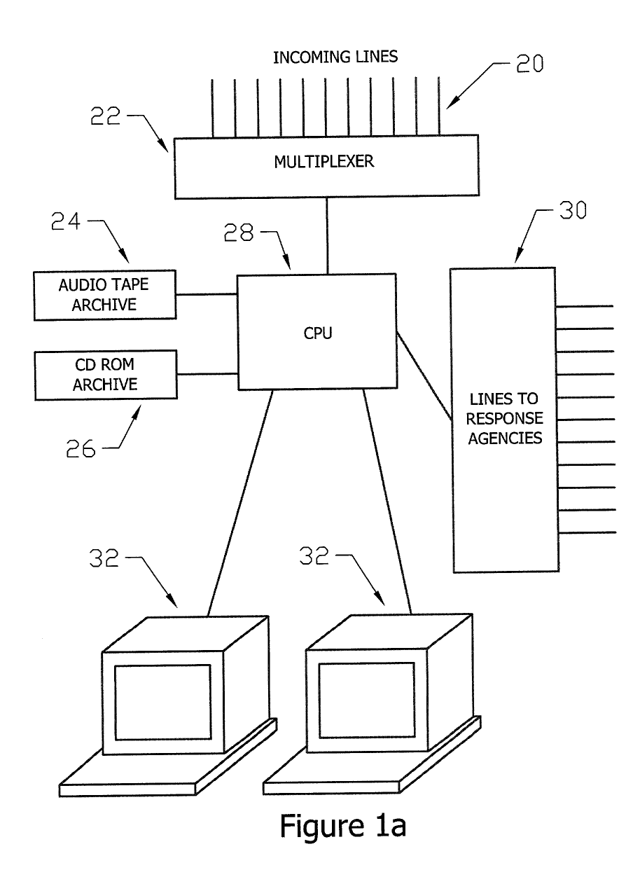

FIG. 1 shows a basic 911 PSAP system in the context of an overall phone and dispatch system. Cellular phone 2 transmits a 911 call to a base station 4. Base station 4 then transmits over a microwave or hard connection (copper wire or optic fiber) to the 911 “Tandem Office” 8. Tandem Office 8 is also connected to a conventional wired phone 6. The office 8 then transmits its call to the PSAP 10 with operator control at PSAP 10 so the call will be routed to the dispatch station 12 (for the appropriate emergency response) to be typically transmitted over antenna 14, to a radio equipped emergency vehicle.

Multiple base stations may be used to derive location information of the calling party. Such systems are taught by Hatakeyama, “Mobile Communication System,” (U.S. Pat. No. 5,542,100) and Bustamante, “Wireless Telephone User Location Capability for Enhanced 911 Application,” (U.S. Pat. No. 5,548,583). In the alternative, a cellular phone may be connected to a global positioning system (GPS) receiver as taught by Grimes, “Cellular Terminal for Providing Public Emergency Call Location Information,” (U.S. Pat. No. 5,479,482).

FIG. 1a gives a basic structure of the instant invention. Incoming lines 20 are connected to a multiplexer 22, which feeds the audio phone signal to CPU 28. The CPU 28 is in turn connected to an audiotape archive 24 and a CD Rom archive 26. The audiotape archive continuously records everything that is said on the incoming phone lines by the calling party and the operators. The CD-ROM archive stores the above information in a compressed format along with the phone number of the calling party, the base station used, and the time. This is important in case the caller hangs up and information is needed for the identity of a witness.

Several operator consoles 32 are connected to the CPU, which in turn is connected to outgoing line system 30 for connection to the various response agencies.

In operation, a 911 call would come in and, based on the triage methods taught in this invention, would be assigned a location in a queue. When the call came up for answering the operator would briefly interact with the calling party and push the appropriate button to dispatch the call to the correct response agency.

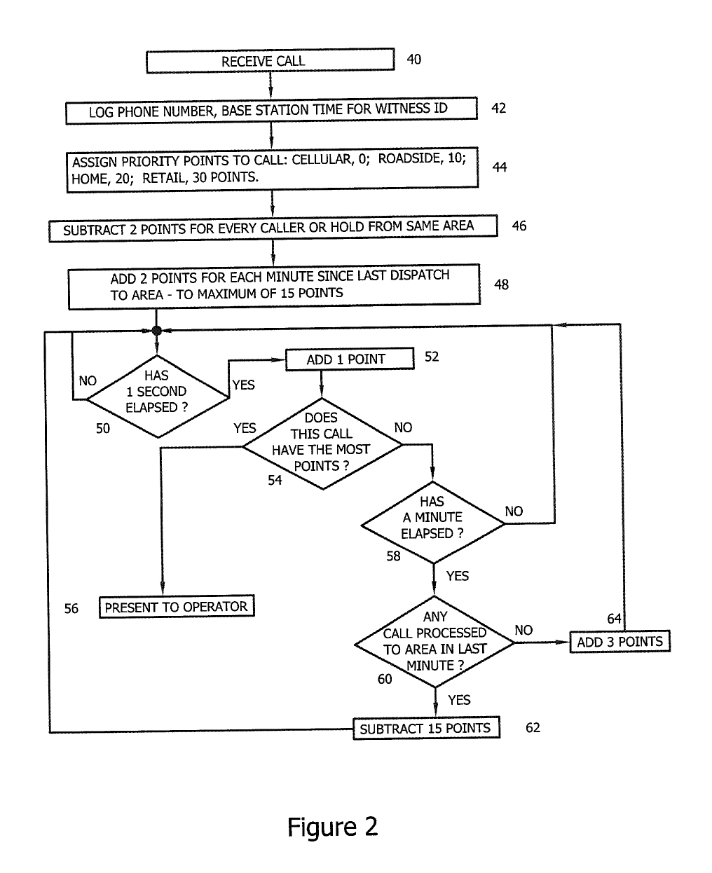

The basic method of the preferred embodiment of the instant invention is given in FIG. 2. The goal of this method is to progressively shave out redundant calls. This is necessary, for example, due to the multiplicity of cellular calls that arrive for each highway incident.

A further goal is to give high priority to calls that may represent a violent crime in progress.

The first step 40 of the method is to receive the call. Step 42 is to log the phone number, base station used (if any) and time for possible identification of a later witness in case of a hang up. Any location information would also be logged at that point. If the caller were calling from a wired phone this location information would be provided automatically through the conventional automatic location identification (ALI) system.

In step 44 priority points are assigned. A retail store receives 30 points due to the possibility of the call reflecting a customer cardiac arrest or armed robbery. A home call would receive 20 points. A call from a fixed roadside station would receive 10 points, as they are typically nonemergency requests for a tow truck. A cellular phone call would receive 0 points, as there is usually a very high level of duplication in these calls.

In Step 46 a correction is made for possible duplicate calls. For each caller on hold from a given area 2 points are automatically subtracted. The definition of area can vary. A simple definition would be a common base station for cellular phones. Thus if there were five 911 calls coming into a single base station there is a very high likelihood that these are duplicate calls. Each caller would then receive a penalty of 2×5 or 10 points. For wired phones, a radius of 2 miles (as calculated from the ALI information) could be used. Negative numbers are allowed in this scoring system.

In Step 48 a correction is made for the possibility that there is a new incident in the area. Thus for each minute since the last dispatch to an area two points are added to each call from that area. This is limited to a maximum of

15 points. For example, if the police were dispatched to an accident seven minutes ago and a new call just came in from that area there is a possibility that the new call is referring to a different incident. That call thus receives 14 additional priority points.

The call is now placed into the hold queue. In Steps 50 and 52 one point per second is added for the time that a call is on hold. The presumption is that a serious caller is likely to be patient and wait as opposed to a casual caller that may hang up immediately when they find that they are on hold.

At Step 54 the system asks if this call has the most points. If it does then the call goes to Step 56 and is presented to the next operator in sequence. If the call does not have the most points then the method progresses to Step 58. Here a test is made to see if the caller has been on hold for another minute. If the caller has been on hold for another minute then the method proceeds to Step 60 and asks if any call has been processed to that area in the last minute.

If there has been no such previously processed call in the last minute (to the caller's location) then three priority points are added to the new call's score for that minute (and for each succeeding minute). The rationale for this is that the present caller is probably calling about a fresh incident since there has been no recent dispatch to the area.

If there has been a call processed within that area in the last minute then there is a high likelihood that this new call is a duplicate call and 15 points are subtracted from this caller's priority score.

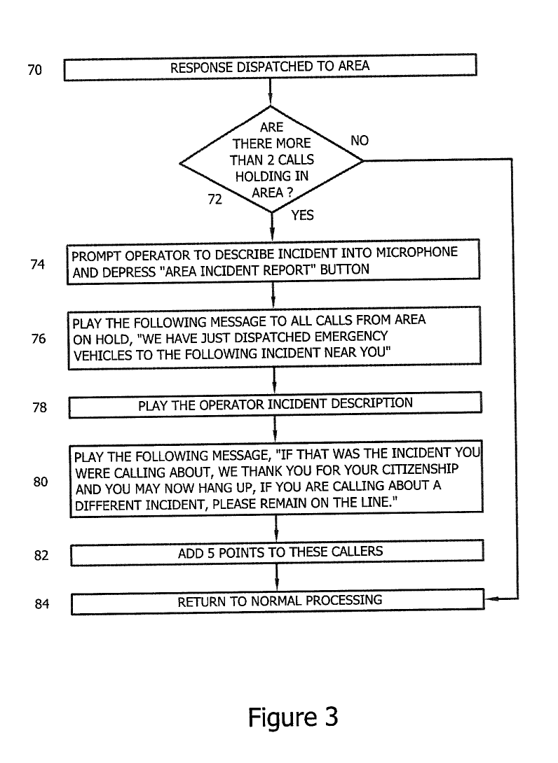

FIG. 3 describes the automated interactive triage method of the instant invention. This provides for an updated hold message to help the caller decide if they are indeed making a duplicate call.

At Step 70 a response is dispatched to an area. At Step 72 the system asks if there are more than two calls holding in that area of the dispatch. If there are not then the system returns to normal processing at Step 84. If there are more than two calls holding in the area then one can suspect that there is high likelihood that these are duplicate calls. At Step 74 the system prompts the operator to describe the incident into a microphone and depress the “Area Incident Report” button. This would result in a very abbreviated statement such as, “There is a rollover on Highway 101 at mile marker 93.”

In Step 76 the system will play the following message to all calls on hold from that area, “We have just dispatched emergency vehicles to the following incident near you.” At Step 78 the system then immediately plays the operator incident description that had been recorded just previously. I.e., it goes on to say, “There is a rollover on Highway 101 at mile marker 93.”

In Step 80 the system goes on to play the following closure message, “If that was the incident you were calling about, we thank you for your citizenship and you may now hang up. If you are calling about a different incident, please remain on the line.”

In Step 82 five points are added to the score for each caller who remained on hold after this message has been played. This is due to the high likelihood that these callers are referring to a new incident. The call then returns to normal processing as described in FIG. 2.

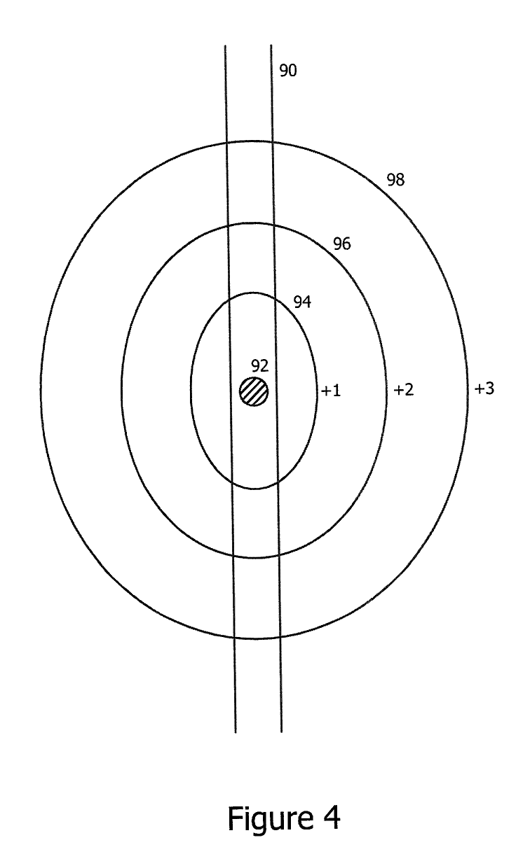

FIG. 4 describes the elliptical scoring method of the instant invention for use of sophisticated location information. As mentioned earlier, there are several ways to determine the location of a caller. For a wired line the existing ALI system works. For cellular phones one could use a GPS position transmission, the base station connected to, or various “triangulation” systems for determining a more precise location as discussed in Grimes, Hatakeyama, or Bustamente, for example.

This location information could be used to perform a more sophisticated triage on callers. For example, let's imagine that an incident occurs on Highway I-40 shown as location 92 in the figure. If a call comes in along the highway and relatively close to incident 92 there is a high likelihood that it is a duplicate call. If, however, the call comes from off of the highway or is further down the road, then there is less of a likelihood that this is a duplicate call. One way to capitalize on this information is to assign an additional priority point per mile that the call is away from the incident in the direction of the highway, but assign two points per mile that the caller is away perpendicular to the highway.

This is due to the fact that the caller perpendicular to the highway is much less likely to have simply driven past the incident on the highway and is more likely to be reporting a new incident. Hence the elliptical scoring regions shown in FIG. 4. Outside of region 94 each caller gets an additional point of priority. Outside of region 96 each caller gets an additional two points priority. Outside of region 98 each caller gets three additional priority points.

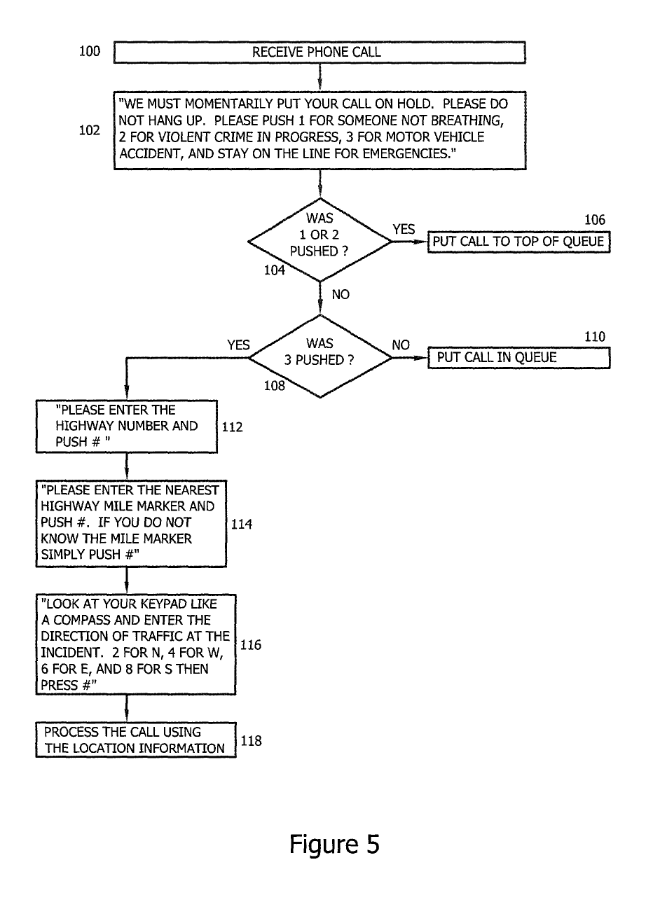

A disadvantage of the this method is that multiple cell phone calls from the same area regarding someone not breathing might not get a high enough priority for timely triage. That is because these embodiments do not have an explicit means for identifying the severity of the emergency. FIG. 5 shows a method refinement for the instant invention, which solves this problem. This embodiment uses “voice mail” techniques to assist in the triage and location of a call. In Step 100 the cell phone call is received. In Step 102 a message is delivered, “We must momentarily put your call on hold. Please do not hang up. Please push 1 for someone not breathing, 2 for a violent crime in progress, 3 for motor vehicle accident, and stay on the line for other emergencies.”

In Step 104 the system asks if number 1 or 2 was pushed. If so, this is an extreme emergency and the system goes to Step 106 to put the call to the top of the queue for response.

If neither of those buttons were pushed, then the system goes to Step 108 and asks if button number 3 was pushed. If it was not, then the call goes into the normal queue in Step 110. If the button was pushed, then the system goes to Step 112 and prompts, “Please enter the highway number and push #.” The system then goes to Step 114 after receiving a response and prompts, “Please enter the nearest mile marker and push #. If you do not know the mile marker, simply push #.” The system will then go on to Step 116 and prompt, “Look at your keypad like a compass and enter the direction of traffic at the incident. Enter 2 for North, 4 for West, 6 for East, and 8 for South. Then push #.” Finally, the system will, in Step 118, continue to process the call using the location information according to the other methods taught in this invention. It then properly places the call in the queue

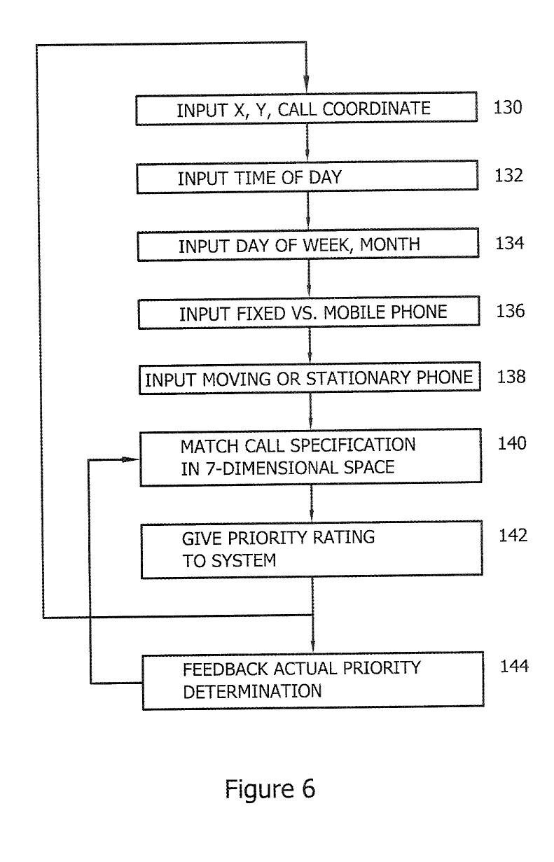

FIG. 6 shows another feature of this invention through the use of collaborative filtering to find the optimal priority rating for a call. For clarification FIG. 6 shows those steps that have primarily not been discussed earlier in this specification. Some of those earlier-discussed features such as the number of calls from a certain area would be added to this collaborative filtering feature in this alternative embodiment.

At step 130 the method will input the “x” and “y” call coordinates. These coordinates are derived from the ANI (automatic number identification commonly referred to as “Caller ID”) or GIS (graphical information system) location equipment as is now used in present precepts.

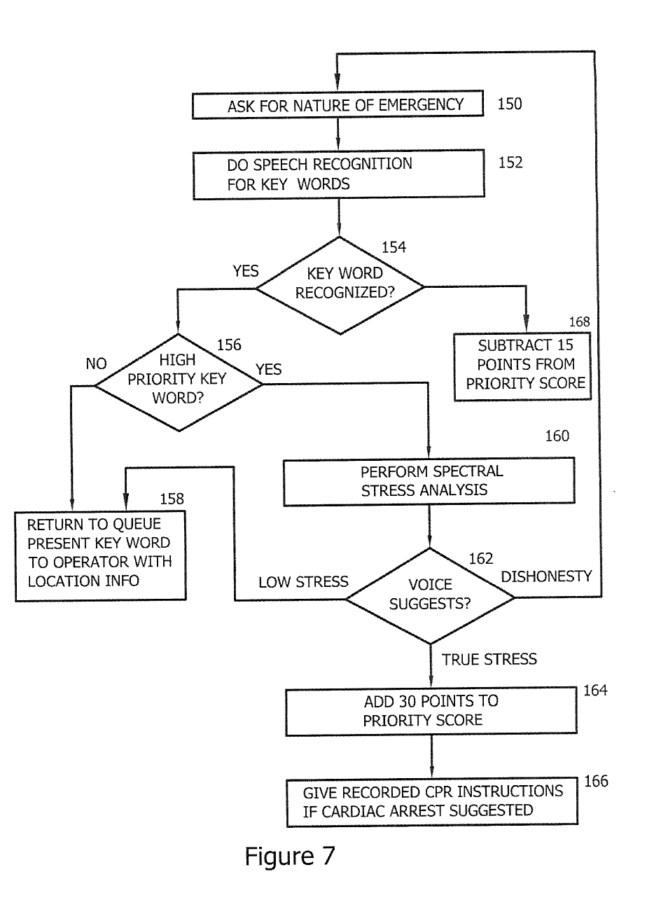

In step 132 the system will input the time of day. Following that the system will input the day of the week or month at step 134 and then go on to input a Boolean variable in step 136 as to whether the call is from a fixed or mobile phone. Finally the Boolean variable of a moving or stationary phone is input at step 138. The system now has seven variables (x, y, time, day of week, day of month, fixed vs. mobile, and mobile vs. stationary). This is then matched to the closest experience in seven dimensional space for other such calls. The priority reading for those closest calls is then assigned to this call in step 142. This is presented to the operator or added into the other priority score according to the earlier discussion. Finally, when the call is resolved the operator will be prompted to give the correct priority for this call in step 144 and that will be fed back into the database at step 140. This will ensure that the database presents the most accurate call experience and thus the collaborative filtering will have the most accurate response. FIG. 7 shows an enhancement embodiment of the present invention relying on spectroanalysis and speech recognition. In step 150 the system asks for the nature of the emergency. At step 152 the system does speech recognition for key words. These would be words such as “heart attack”, “breathing”, or “dead.” At step 154 the system will then ask if there were any key words recognized. If there were not then the system goes on to step 168 where 15 points are subtracted from the priority score. If key words were recognized then the system will go on to step 156. At that point the system will grade the key words that were found. If they were high priority key words then the system will go to step 160. If the key words were not a high priority then the system will go on to step 158, which is to return to the queue. The system will present the key words to the operator along with the location information when the call rises to sufficient priority for operator presentation.

Return to the case of high priority key words that are recognized at step 156. At this stage the system will want to go to step 160. There the system will perform a spectral stress analysis of the speaking. In step 162 the system asks if the voice suggests low stress, true stress, or dishonesty. Multiple studies have shown that patients in true stress or dishonesty tend to have a more monotone voice. By looking at further characteristics of this spectrum the system will be able to distinguish between the stress from lying (dishonest) and the stress because of the nature of the emergency (“True Stress”). Stress from lying tends to add a low frequency faltering to the monotonic main frequencies while honest true stress tends to only add the monotonicity. If the system detects low stress then it will go to step 158. If the system detects dishonesty then the system will go back and ask for the nature of the emergency again at step 150. This way, if the system is truly picking up a call of someone with a true emergency they will have another chance to explain what is going on. The annoyance of being recycled should be enough to provoke true stress if the caller is dealing with a real emergency. If true stress is detected at step 162 then the system will go on to step 164 where it will add 30 points to the priority score that the call already had based on its other call characteristics. At step 166 the system will give recorded CPR instructions if cardiac arrest was suggested by the key word recognition. The key words which would suggest this would be “dead”, “breathing”, etc. in the absence of trauma indication words such as “shot” or “stabbed.” Of course, the system at this point would have presumably raised the call to high enough priority that a human operator would be on the line, but in the seconds of waiting the delivery of CPR instructions could be very useful.

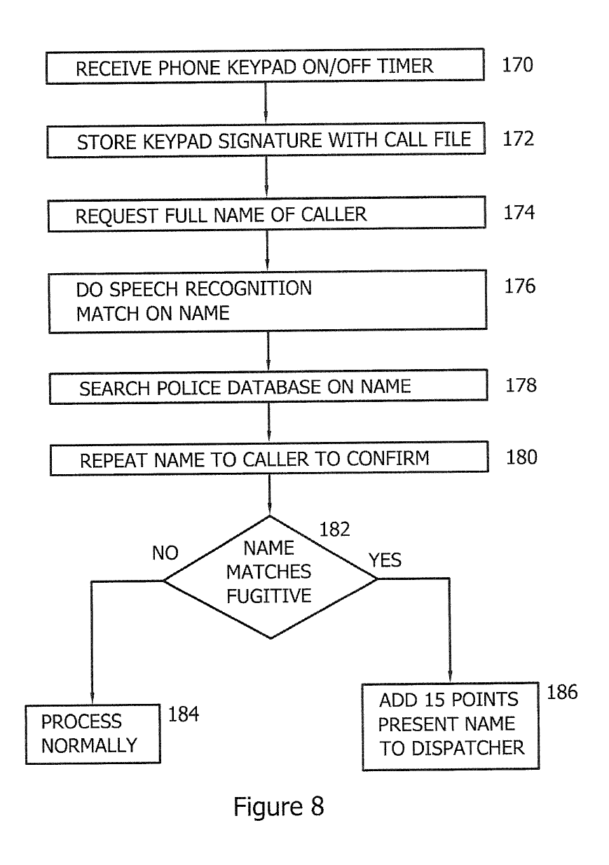

FIG. 8 deals with the method of this invention that covers identification procedures. In step 170 the system will receive the phone keypad on/off times. Everyone dials a phone with a different signature. They may hold one key down for 320 ms and have a space of 550 ms before dialing the next button and so forth. Details of this approach are covered in ATM Signature Security System, (U.S. Pat. No. 6,062,474) and Keyboard Signature Security System, (U.S. Ser. No. 09/571,980) both of which are included by reference in their entirety.

In step 172 the keyboard signature is stored with the call file for later identification. In step 174 the system requests the full name of the caller. In step 176 the system will do a speech recognition match on that name. In step 178 the system will search the police database for that name. In step 180 the system will repeat the name to the caller to confirm. In step 182 the system will attempt to match the caller identification with a fugitive. It will do this by attempting to match the name, spectral voice characteristics (even if the individual lied about their name), and the keypad signature. If there is no match then the system goes to step 184 and does a normal process. If there is a match then the system goes to step 186 and adds 15 points to the priority score and presents the name and the felony record to the dispatcher.

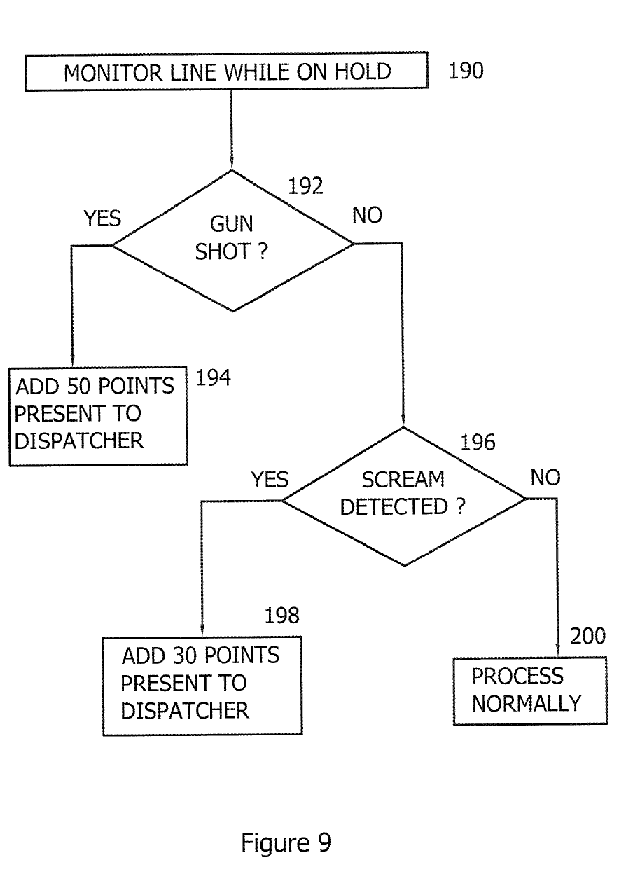

In FIG. 9 the system performs spectral analysis to find gunshots and screams. This process begins at step 190 where the system will monitor the line while the individual is on hold. At step 192 the system performs a spectral analysis to look for the characteristic signatures of a gunshot. If a gunshot is heard then the system goes to step 194 where the call receives an additional 50 points and the gunshot information is presented to the dispatcher.

If there is no gunshot detected then the system goes to step 196 and asks if a scream is detected. If a scream is detected then the system goes to step 198 and adds 30 points to the priority score and presents the scream information to the dispatcher.

If there is no scream detected then the system goes to step 200 and processes everything normally.

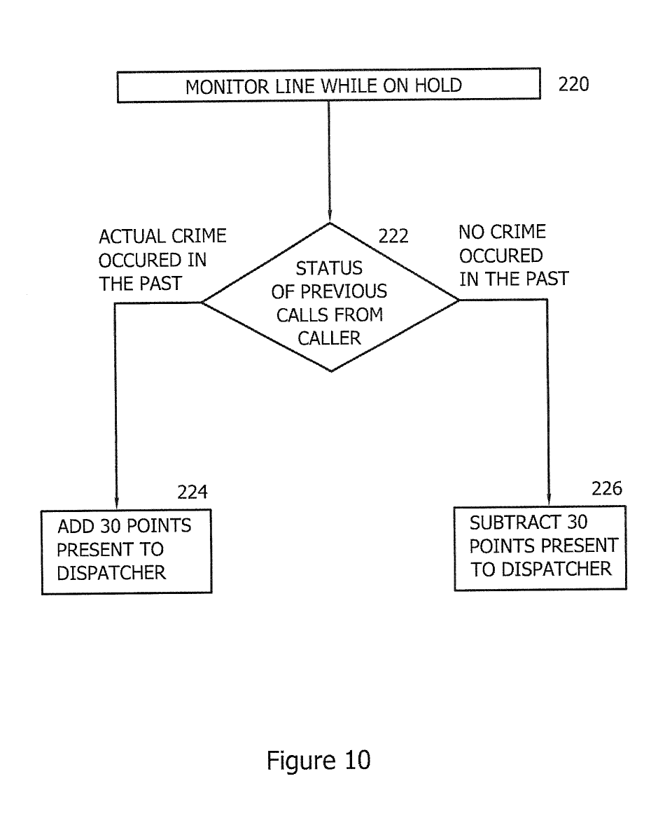

FIG. 10 shows an enhancement embodiment using the false alarm rating for a given address. The system monitors the line while the caller is on hold at step 220. At step 222 the system pulls up previous call records to see if previous calls were false alarms or represented true crimes reliably. If the most recent previous call was of an actual crime then the system will add 30 points to the priority score in 224. If, on the other hand, the previous call was a false alarm, then at step 226, the system will deduct 30 points from the priority score.

Clearly many variations of the basic invention can be imagined and are intended to be covered by this patent. We anticipate a multitude of different triage techniques and scoring systems and a multitude of different voice interactions with the calling party without departing from the spirit of this invention. For example, the above embodiments teach the use of a linear additive and subtractive score. One could employ the ideas of this invention with nonlinear score calculating techniques including multiplicative scores, neural networks, Bayesian conditional probabilities, logistic regression, and general nonlinear regression.

1. A public safety answering point comprising:
phone call receiving circuitry,
a central processing unit connected to said circuitry,
operator consoles connected to the central processing unit, with the central processing unit executing a stored program to select the highest priority calls for presentation to the operator console,
where the priority score is calculated from the length of the time the caller has been in the queue,and
one other factor besides the amount of time in the queue, so as to automatically triage incoming emergency phone calls so that the most critical ones are answered first.

2. The public safety answering point of claim 1 in which the call location is used as one other factor to assign priority.

3. The public safety answering point of claim 1 in which the likelihood of a call being a duplicate is used as one other factor to assign priority.

4. The public safety answering point of claim 1 in which the caller receives a customized hold message depending upon their location.

5. The public safety answering point of claim 1 in which the caller receives a customized hold message describing an incident that the caller may be referring to.

6. The public safety answering point of claim 1 in which the priority is adjusted by the orientation of the vector of a known existing incident to the caller with respect to the roadway of the known existing incident's orientation.

7. The public safety answering point of claim 1 in which the caller is prompted to enter location information with the telephone keypad.

8. The public safety answering point of claim 1 in which the stress in the voice is used as one other factor to assign priority.

9. The public safety answering point of claim 1 in which the presence or absence of key words in the oral communication is used as one other factor to assign priority.

10. The public safety answering point of claim 1 in which automatic CPR instructions are given if cardiac arrest is suggested.

11. The public safety answering point of claim 1 in which the keypad signature is analyzed.

12. The public safety answering point of claim 1 in which speech recognition is performed on the oral communication of the caller.

13. The public safety answering point of claim 1 in which the caller's name is requested and then matched against law enforcement databases.

14. The public safety answering point of claim 1 in which the presence of gun shot sound is used as one other factor to assign priority.

15. The public safety answering point of claim 1 in which the presence of a human scream is used as one other factor to assign priority.

16. The public safety answering point of claim 1 in which the history of the reliability of previous calls from the location is used as one other factor to assign priority.

17. A method for processing emergency calls comprising the steps of:
connecting to a call,
assigning a priority score to the call, and
answering the call with the highest priority score where the priority score is calculated from the length of the time the caller has been in the queue,and
at least one other factor besides the amount of time in the queue, so as to automatically triage incoming emergency phone calls so that the most critical ones are answered first.

18. The method for processing emergency calls of claim 17 in which the call location is used as one other factor to assign priority.

19. The method for processing emergency calls of claim 17 in which the likelihood of a call being a duplicate is used as one other factor to assign priority.

20. The method for processing emergency calls of claim 17 in which the caller receives a customized hold message depending upon their location.

21. The method for processing emergency calls of claim 17 in which the caller receives a customized hold message describing an incident that the caller may be referring to.

22. The method for processing emergency calls of claim 17 in which the priority is adjusted by the orientation of the vector of a known existing incident to the caller with respect to the roadway of the known existing incident's orientation.

23. The method for processing emergency calls of claim 17 in which the caller is prompted to enter location information with the telephone keypad.

24. The method for processing emergency calls of claim 17 in which the stress in the voice is used as one other factor to assign priority.

25. The method for processing emergency calls of claim 17 in which the presence or absence of key words in the oral communication is used as one other factor to assign priority.

26. The method for processing emergency calls of claim 17 in which automatic CPR instructions are given if cardiac arrest is suggested.

27. The method for processing emergency calls of claim 17 in which the keypad signature is analyzed.

28. The method for processing emergency calls of claim 17 in which speech recognition is performed on the oral communication of the caller.

29. The method for processing emergency calls of claim 17 in which the caller's name is requested and then matched against law enforcement databases.

30. The method for processing emergency calls of claim 17 in which the presence of gun shot sound is used as one other factor to assign priority.

31. The method for processing emergency calls of claim 17 in which the presence of a human scream is used as one other factor to assign priority.

32. The method for processing emergency calls of claim 17 in which the history of the reliability of previous calls from the location is used as one other factor to assign priority.
